(19) United States
(12) Patent Application Publication
(10) Pub. No.: US 2005/0174567 A1
(43) Pub. Date: Aug. 11, 2005

(54) Crack detection system

(75) Inventor: James L. Hanna, Saline, MI (US)

Correspondence Address: Robert K. Fergan;BRINKS HOFER GILSON & LIONE, P.O. Box 10395, Chicago, IL, 60610, US

(73) Assignee: Mectron Engineering Company

(21) Appl. No.: 10/774,940

(22) Filed: Feb. 9, 2004

(51) Int. Cl. G01N 21/88

(52) U.S. Cl. 356/237.1

(57) ABSTRACT

A system is provided to determine the presence of cracks in parts. The presence of cracks is determined through the use of an imaging device and illumination source. The part is moved along a track where it is sensed by a position sensor to initiate the inspection. The illumination source projects a sheet of light onto the part to be inspected. The line formed by the intersection of the sheet of light and the part is focused onto the imaging device. The imaging device creates a digital image which is analyzed to determine if cracks are present on the part.

### BACKGROUND

### 1. FIELD OF THE INVENTION

This invention relates to a device for inspecting components and particularly to one using an array of light sources and photodetectors as a means for evaluating a part for conformance to crack specifications.

Presently, there is an ever increasing demand to obtain high quality products which has resulted in a significant increase in the use of non-contact inspection systems. In order for a complex machine to operate as designed, it is necessary that all of its sub-components comply with quality criteria. In some manufacturing settings, customers require 100% inspection of component parts. For example, fasteners used in the automobile industry and elsewhere often must be individually inspected to determine if they meet product specification.

When producing fasteners, the process often begins with wire stock which is fed into a cold heading or screw type forming machine. The part is die-formed or cut in a machine into a shape that may include several diameters and possibly a threaded or knurled length. The formed part may require secondary operations such as thread rolling, heat treating, plating etc. It is not uncommon for one or more of the processes to produce a crack in the part. The occurrence of such defects is often not adequately monitored through random part selection or other quality assurance processes which do not provide 100% inspection. The inspection system of this invention is also highly adaptable for evaluating various components.

A variety of non-contact inspection systems are known using a variety of techniques. For example, eddy current inspection systems examine the electric field transmitted through a part as a means of characterizing cracks in the part. Various systems based on a video image of a part are also known. In addition, laser gauging systems are used for obtaining specific dimensional measurements.

Although known non-contact inspection systems are generally extremely useful, they have certain limitations. Many of the presently available non-contact gauging systems require complex data processing approaches which impose expensive hardware requirements and can limit the speed with which evaluations can be accomplished. Preferably, evaluation of a workpiece can be conducted in a rapid enough fashion that the parts can be directly sorted into qualified or disqualified part streams. Many of these prior art systems also tend not to be easily adapted to various part configurations. Moreover, many prior art systems, although performing adequately in a laboratory setting, are not sufficiently rugged for a production environment where temperature variations, dust, dirt, cutting fluids, etc. are encountered.

### SUMMARY OF THE INVENTION

In accordance with the present invention, an embodiment of an improved non-contact inspection system is provided which enables rapid inspection to be conducted permitting parts to be immediately sorted in terms of being in conformance or out of conformance with crack specifications. The parts move by gravity or other means along a track through a test section. The presence of cracks is determined through use of a imaging device. A collimated uniform light source in the form of a sheet is generated in the proximity of the part to be inspected. This uniform sheet of light will intersect the part forming a line on the surface of the part, allowing a highly detailed part examination. As the part moves through the test section containing the imaging device, a line will be formed on the part by the sheet of light intersecting with the surface of the part. An optical system will focus the light reflected from the surface onto the imaging device. The processor will analyze a digitized image of the line to identify cracks in the part.

The system utilizes a plurality of light sources and imaging devices in a radial arrangement around the part to be examined. The imaging device will analyze the light intersecting the part from a matched or paired light source which is proximate to the part. In an embodiment of the invention, a light source is coupled to a diffractive beam shaper which provides a sheet of light with improved uniformity. The uniform sheet of light is used to attain a uniform intensity pattern over a portion of the part. The gaps in the line created by cracks in the parts are accentuated because the uniform sheets of light are indistinct and lack sharp transitions. Each light source is modulated, such that, each imaging device will detect illumination only from its matched illumination source. In this manner, there will be no cross-talk generated between the light sources and other imaging devices.

Further objects, features, and advantages of the invention will become apparent from a consideration of the following description and the appended claims when taken in connection with the accompanying drawings.

### BRIEF DESCRIPTION OF THE DRAWINGS

FIG. 1 is an isometric view of a system to inspect parts for cracks in accordance with the present invention;

FIG. 2 is a side view of the test section of a system to inspect parts for cracks according to the present invention;

FIG. 3 is a front view of the test section of a system for inspecting parts for cracks according to the present invention;

FIG. 4 is a base plate of the test section in accordance with the present invention;

FIG. 5 is a top view of the illumination source in accordance with the present invention;

FIG. 6 is a cutaway isometric view of the test part and track according to the present invention; and

FIG. 7 is an illustrative view of the digital image generated by the system to inspect for cracks in accordance with the present invention.

### DETAILED DESCRIPTION

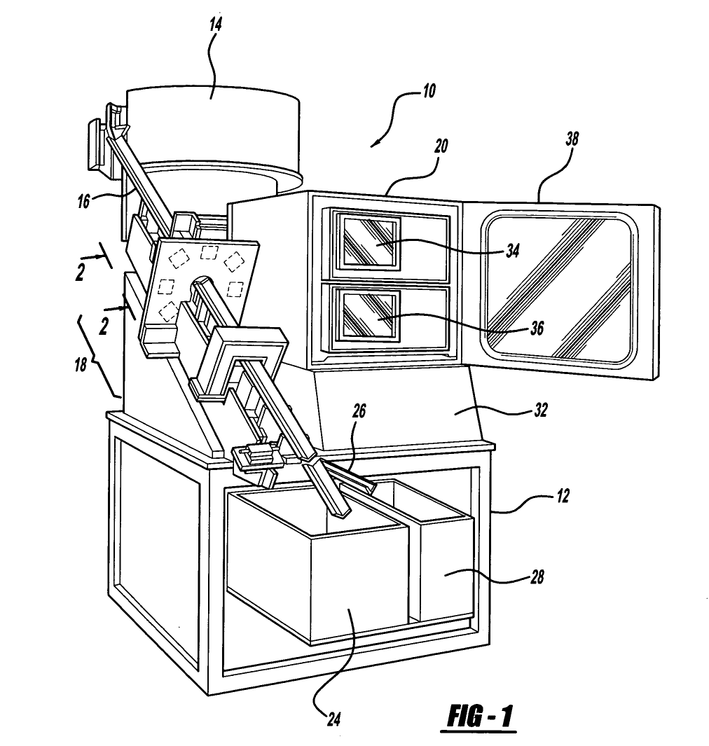

A non-contact inspection system in accordance with the present invention is shown in FIG. 1 and is generally designated by reference number 10. Inspection system 10 generally comprises frame 12, part sorter 14, slide track 16, and enclosure 20 for housing electronic components of the instrument. Portions of the system 10 form a test section 18 where inspection of the workpieces generally occur.

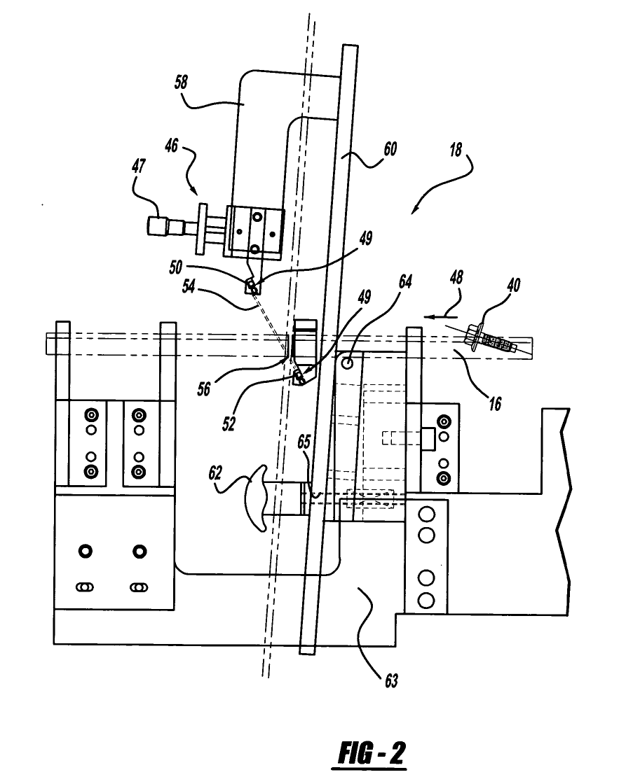

While inspection system 10 can be used for numerous types of workpieces, an example of one such component is provided in FIG. 2 in the form of a threaded bolt 40 used for mounting the road wheels of a motor vehicle. A large number of bolts 40 (referred to also as “parts” or “workpieces”) are dumped into part sorter bin 14. Part sorter 14 causes the randomly oriented bolts 40 to be directed in a desired orientation i.e. headed or threaded end first, and causes them to periodically slide down track 16 under the force of gravity. As parts 40 pass through test section 18, they are evaluated as will be described in more detail in the following portions of this specification. Bolt 40 is inspected for conformance with predetermined surface crack criteria. If a particular part meets the criteria, it passes into parts bin 24 provided for qualified or “good” parts. If, however, the part is deemed to be out of conformance, gate 26 is actuated and the part is diverted into parts bin 28 provided for disqualified or “bad” parts.

Within enclosure 20 is housed computer 32 provided for evaluating the outputs of the system, controlling the system, and providing a means of storing data related to part criteria and inspection history. A pair of displays 34 and 36 are provided, one of which may output in graphical form configuration data for a particular part, whereas the other may be used for outputting statistical or other numerical data related to inspection. In a prototype embodiment of this invention, displays 34 and 36 were electroluminescent types having touch screens for interaction with the user. Enclosure 20 has access door 38 which can be closed when the system is not in use.

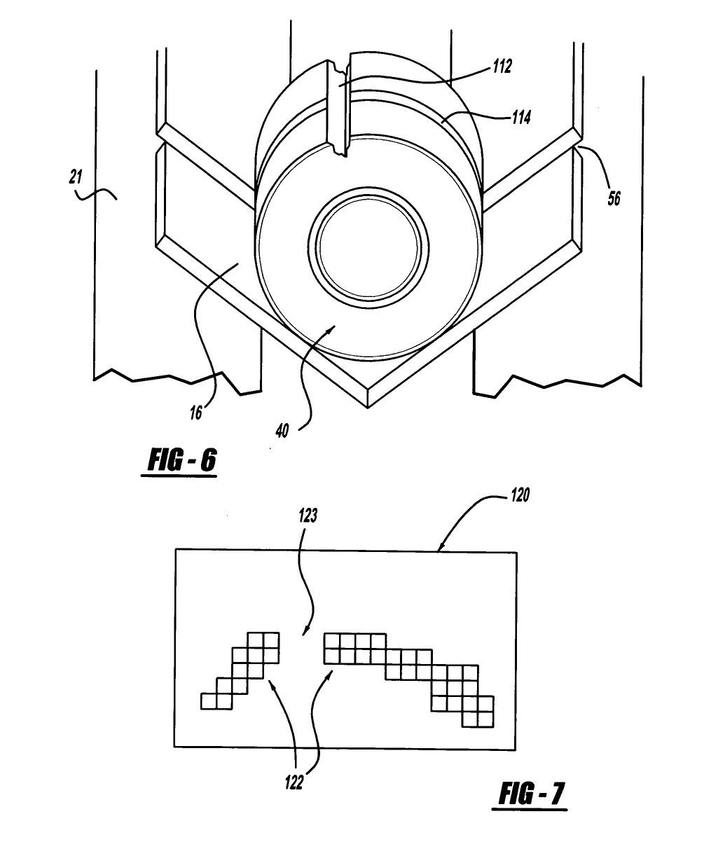

Details of the elements and operation of test section 18 will be described with reference to FIGS. 2 through 6. As shown in FIG. 2, the test section 18 generally includes a portion of the track 16, a position sensor 49, illumination sources 70, and imaging devices 80. A part is transported along the track 16 in the direction indicated by arrow 48. The track 16 is positioned at an angle allowing gravity to move the part along the track 16. Alternatively, other mechanical methods, such as belts, rollers or fingers may be used to propel the part along the track 16. The track 16 is designed as a V-track causing generally cylindrical parts such as bolts to align their cylindrical axis with the center of the track 16. A gap 56 is located in the track 16 allowing a portion of the part to be viewed from any angle within the plane of the gap 56.

To initiate an inspection sequence, a sensor 49 is provided to detect when the part 40 is in a position appropriate for initiating the inspection. The sensor 49 includes a transmitter 50 and a receiver 52. The transmitter 50 is located to project a beam of light 54 to the receiver 52 which travels through the gap 56 in the track 16. As the part 40 travels along the track 16 in the direction of arrow 48, a first edge of the part will break the beam path 54 causing the receiver 52 to generate a signal indicating that the part 40 is in position for the inspection to begin. The transmitter 50 is attached to a locating bracket 58 through an adjustable mount 46. The adjustable mount 46 includes a micrometer screw 47 that adjusts the location of the transmitter 50 thereby adjusting the part location at which the system will begin inspection. The bracket 58 is attached to the reference plate 60.

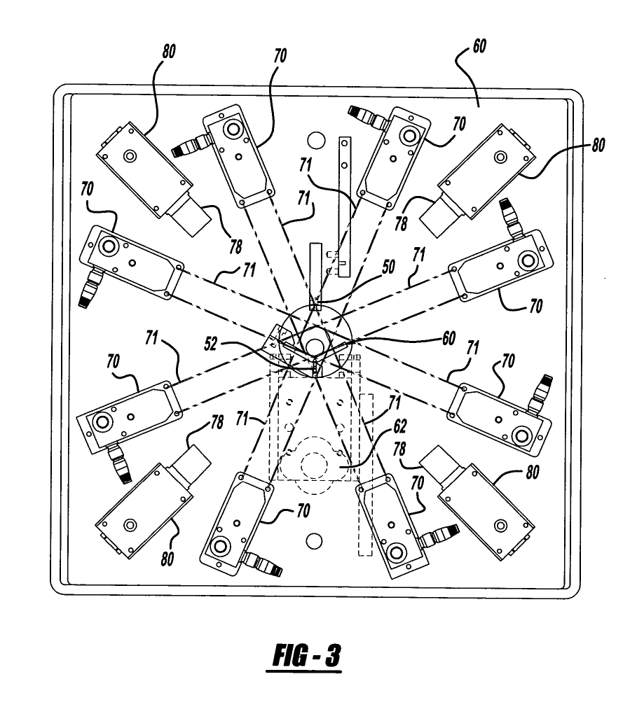

As shown in FIG. 3, the reference plate 60 supports the illumination sources 70 and imaging devices 80 used for detecting cracks in the surface of the part. Multiple illumination sources 70 are radially spaced around the part. Each illumination source 70 projects a sheet of light 71, having a length greater than the width, parallel to the reference plate 60 and located to project through the gap 56 in the track 16 intersecting the surface of the part. Similarly, multiple imaging devices are radially spaced about the part having their optical axis roughly parallel to the reference plate 60 and located such that the optical axis passes through the gap 56 in the track 16. The position and orientation of the imaging device 80 allows a line of reflected light, formed by the sheet of light 71 intersecting the part, to be viewed by the imaging device 80. Ideally, the sheet of light 71 projected from the illumination sources 70 and the optical axes of the imaging devices 80 are perpendicular to the cylindrical axis of the part and unobstructed by the track 16.

In the example of inspecting bolts 40, the diameter of the head of a bolt is often larger than the diameter of the threaded portion of the bolt causing the cylindrical axis of the part 40 to be at an angle relative to the track 16. To optimize the amount of light reflected from the part 40 to the imaging device 80, it is preferable for the illumination source 70 and the imaging device 80 to be perpendicular to the cylindrical axis of the part 40. To accommodate variations in the part affecting the angle between the cylindrical axis of the part and the track, the angle of the reference plate 60 is adjustable. Advantageously, the angle of all imaging devices 80 and illumination sources 70 are adjusted by changing the angle of the base plate 60. Additionally, the base plate 60 rotates about the pivot point 64. Further, the pivot point 64 maintains alignment of the illumination source 70 and the gap 56. For convenience, a handle 62 is attached to a threaded shaft 63. As the handle 62 is turned, the threaded shaft 63 advances causing the handle 62 to push against the base plate 60 thereby providing an adjustment in the angle of the base plate 60.

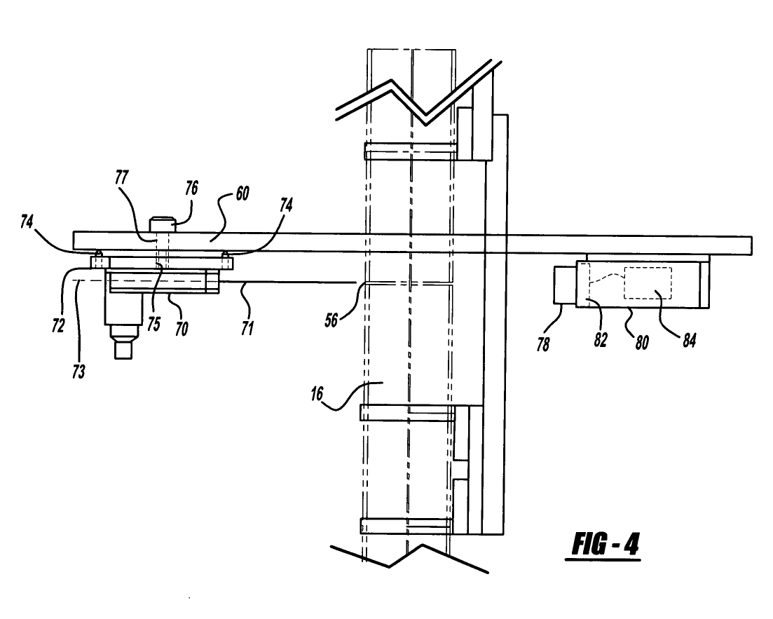

As shown in FIG. 4, the illumination source 70 is adjustably mounted to the base plate 60 through a mounting plate 72. The plate 72 is attached to the reference plate 60 by a screw 76. Screw 76 passes through a bore 77 in the reference plate and is threaded into a bore 75 in the mounting plate 72. In addition, adjustment screws 74 are threaded through the mounting plate 72 to provide a level of fine adjustment of the optical axis of the illumination source 70 relative to the surface of the reference plate 60. The sheet of light 71 is projected along the optical axis 73 of the illumination source 70. The orientation of the illumination source 70 is such that the sheet of light is projected through the gap 56 and the track 16 allowing the radially spaced illumination sources 70 to fully illuminate the circumference of the part 40.

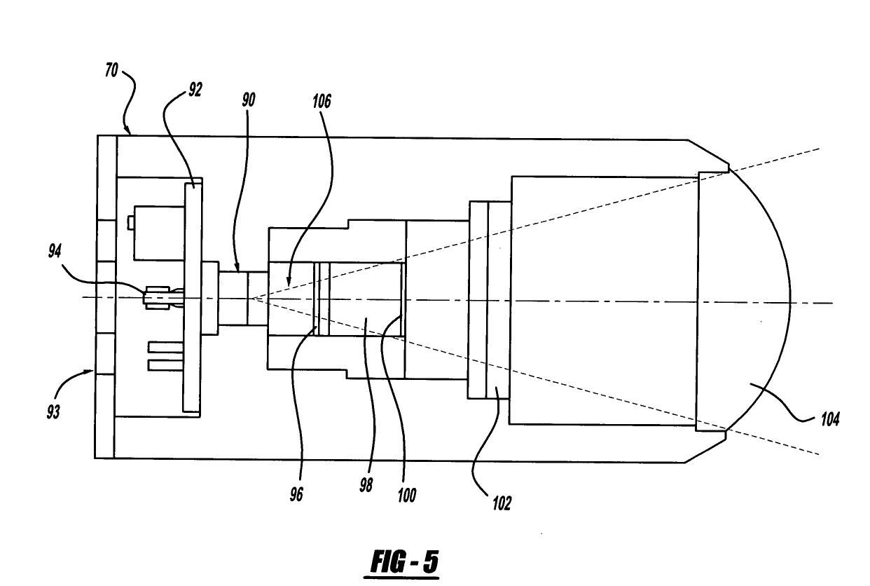

Referring to FIG. 5, an embodiment of the light source 70 is detailed. A framework 93 supports and encloses control and power circuitry including a laser control board 94 and a glass board 92 for the light source 70. A laser diode 90 has a power intensity which is controlled by the laser control board 94 which may be further connected to an external control system by a data communication link so that it may be integrated into a manufacturing line. Although a laser diode 90 is shown, any other type of light or laser light generator such as alternate semiconductor lasers, gas lasers, solid state lasers, and liquid dye lasers may be used with the present invention.

The laser diode 90 generates laser light 106 which is incident upon a diffractive beam shaper 96 that maps an input intensity distribution to an output intensity distribution. The diffractive beam shape 96 may include gratings, prisms, grisms, lenses, and interferometers to create the desired fringe patterns and intensity distributions. The fringe patterns will vary in width and orientation depending on the diffractive beam shaper's 96 characteristics. By designing the diffractive beam shape 96 with an appropriate fringe pattern, one can reflect light into different directions based on the equations describing the different characteristics of the diffractive beam shaper 96.

One application of the diffractive beam shaper 96 of the present invention, is to take a Gaussian input (i.e. a Gaussian intensity distribution on the aperture of a beam shaper) and map that to a “top hat” distribution (an ideal top hat intensity distribution has only one intensity value inside a certain radius and zero intensity value outside that radius). The function can be thought of as a general ray deflection function. The most intense light at the center of the Gaussian input is deflected radially outward, while the light in the tail of the Gaussian is deflected slightly inward. In this way the intensity of the output beam can be tailored.

After exiting the diffractive beam shaper 96, the laser light 106 enters a cube polarizer 98 followed by a sheet of ½ wave film 100. The ½ wave film 100 is cut at 22.5° angle. The combination of the cube polarizer 98 and the ½ wave film 100 polarizes the light 106, in such a manner, that the reflection of the light 106 on the part will be viewable at a shallow angle by its paired or matched imaging device 80 while being non-viewable to the other imaging devices 80 radially spaced about the part. This in effect, eliminates cross talk between the illumination sources and improves reliability of the system for detecting cracks.

After exiting the ½ wave plate 100, the laser light 106 is further conditioned by a refractive spherical or cylindrical lens 102. The lens 102 reduces the divergence of the laser light 106 and therefor reduces the need to manufacture more precise diffraction devices in the diffractive beam shaper 96. Additionally, a conventional refractive element might also be used to roughly collimate the output beam. The laser light 106 will finally be conditioned by a convex lens 104 in order to focus the laser light 106. The output of the light source 70 will then comprise a uniform sheet of light 71. By combining diffractive beam shapers and conventional refractive devices, one can produce a family of intensity distributions such as a line that varies as a Gaussian distribution across its width but has a uniform intensity along its length. Furthermore, while the diffractive beam shaper 96 of the present invention is depicted for use with a parts inspection system, it may be used in any other application in which a coherent collimated light source having a uniform intensity distribution may be used.

The imaging device 80 includes a lens 78, a photosensitive array 82, and a processor 84. The lens 78 focuses an image of the line 114, formed by the diffuse reflection of sheet of light 71 intersecting the part 40, onto the photosensitive array 82 of the imaging device 80. The photosensitive array 82 contains rows and columns of discrete photosensing elements which convert incident light into an electrical signal. The strength of the signal is directly related to the intensity of light striking the photosensing elements. The photosensitive array 82 generates an output signal composed of a plurality of digital and analog signals. Each photosensing elements when saturated by an intense light can function as an on condition or when fully blocked can function as an off condition. There are also circumstances when certain photosensing elements may be only partially blocked. During these periods, the photosensing elements can generate analog signals proportional to the amount of light they are receiving. The photosensitive array 82 converts the incident light on each photosensing elements into discrete charge packets. The amount of charge generated or integrated onto each photosensing elements is a function of the integration time, and the intensity and wavelength of the light focused on the photosensing element. Although the photosensitive array is described here as a charge coupled device (CCD) array, other technologies including CMOS and similar arrays are contemplated. In addition, various geometries of sensing arrays are contemplated, for example linear arrays.

As the part 40 triggers sensor 49, the imaging device 90 is electronically shuttered to collect an image of the line 114 formed by the sheet of light 71 on the intersecting part 40. Electronically shuttering the imaging device 80 reduces noise in the image due to motion of the part. Alternatively, the imaging device 80 can be mechanically shuttered or the illumination sources 70 strobed. Further, the head of the bolt 40 can be inspected using a single shuttered digital image, although, the use of multiple digital images are also contemplated.

The photosensitive array 82 creates a digitized image 120 of the line 114 formed by the sheet of light 71 intersecting the part 40. A processor 84 analyzes the digital image 120 to determine if cracks 112 are present in the part 40. The digital image 120 is formed from a number of picture elements which are arranged in rows and columns across the length and width of the digital image. The rows and columns give the picture elements a spatial relationship to other picture elements. In addition, each picture element has an associated brightness value corresponding to the amount of light collected at the corresponding photosensing element or elements on the photosensitive array 82. Groups of picture elements may be identified to corresponding features of the optical image projected on the photosensitive array 82.

The line 114 formed by the sheet of light 71 intersecting the part 40 creates a higher intensity line feature on the photosensitive array 82. The brightness value of the picture elements can be used to identify groups of picture elements 122 corresponding to brighter features in the corresponding optical image, in this instance the intersection line 114. In the occurrence of a crack 112, the reflected light will be discontinuous in the position corresponding to the crack location, as light is absorbed or reflected away from the digital imaging device 80 rather than reflected towards the digital imaging device 80. Therefore, the processor 84 can detect the presence of cracks 112 by identifying groups picture elements 122 corresponding to the line 114 formed by the intersection of the sheet of light 71 with the part 40 cracks are identified as discontinuities 123 in the corresponding group of picture elements 122.

As a person skilled in the art will readily appreciate, the above description is meant as an illustration of implementation of the principles this invention. This description is not intended to limit the scope or application of this invention in that the invention is susceptible to modification, variation and change, without departing from spirit of this invention, as defined in the following claims.

1. A system for detecting cracks in a part, the system comprising:
a means for conveying the part having a surface for orienting the part;
an illumination source configured to project a sheet of light wherein the sheet of light intersects the part;
an optical system configured to focus reflected light from the sheet of light intersecting the part into an image;
a photosensitive array positioned to receive the image and generate an output corresponding to the image; and
a processor configured to detect cracks in the part by analyzing the output of the photosensitive array.

2. The system according to claim 1, wherein the sheet of light intersecting the part forms a diffuse reflection and the image includes the diffuse reflection.

3. The system according to claim 1, wherein the sheet of light intersects the part across the part's width.

4. The system according to claim 1, wherein the sheet of light is a coherent sheet of light.

5. The system according to claim 4, wherein the illumination source includes a laser diode.

6. The system according to claim 5, wherein the illumination source includes a defractive beam shaper optically coupled to the laser diode.

7. The system according to claim 5, wherein the illumination source includes a polarizing cube optically coupled to the laser diode.

8. The system according to claim 5, wherein the illumination source includes a half waveplate optically coupled to the laser diode.

9. The system according to claim 1, wherein the illumination source and the photosensitive array are mounted to a reference plate.

10. The system according to claim 9 wherein an angle of the reference plate is adjustable to simultaneously manipulate the angle of the illumination source and the photosensitive array, relative to the part.

11. The system according to claim 1, wherein the illumination source is mounted to a plate having screw settings to adjust the mounting plate relative to the reference plate.

12. The system according to claim 1, wherein the surface for locating the part forms a track for conveying the part.

13. The system according to claim 12, wherein the track is a V-track.

14. The system according to claim 13, wherein the V-track includes a gap configured to allow the sheet of light to intersect the part around the full circumference of the part.

15. The system according to claim 1, wherein the output of the photosensitive array is a digitized image having a plurality of picture elements corresponding to the sheet of light intersecting the part.

16. The system according to claim 15, wherein the processor is configured to identify the plurality of picture elements corresponding to the sheet of light intersecting the part.

17. The system according to claim 16, wherein the processor is configured to determine the presence of cracks by identifying discontinuities in the plurality of picture elements.

18. The system according to claim 17, wherein the processor is configured to determine the presence of cracks by analyzing the spatial relationship of the picture elements.

19. The system according to claim 1, including a position sensor configured to produce a signal when the part is in an inspection position.

20. The system according to claim 19, wherein the imaging device is electronically shuttered to collect a digital image of the part based on the signal from the position sensor.

21. The system according to claim 19, wherein the position sensor has a transmitter and a receiver located at opposite sides of the part.

22. A system for detecting cracks in a part, the system comprising:
a means for conveying the part having a surface for orienting the part;
a plurality of illumination sources configured to project a sheet of light that intersect the part across the part's width thereby forming a diffuse reflection;
a plurality of photosensitive arrays positioned to receive the dissue reflection in the form of an image and generate an output corresponding to the image, wherein each illumination source of the plurality of illumination sources is associated with a photosensitive array from the plurality of photosensitive arrays to form a source-array pair, the source array pairs being arranged around the part to make a continuous measurement around a perimeter of the part; and
a processor configured to detect cracks in the part by analyzing the output of the photosensitive array.

23. The system according to claim 22, wherein the illumination source includes a laser diode, a diffractive beam shaper optically coupled to the laser diode, a polarizing cube optically coupled to the diffractive beam shaper, and a half waveplate optically coupled to the polarizing cube.

24. The system according to claim 22, wherein the plurality of illumination sources and the plurality of photosensitive arrays are mounted to a reference plate and an angle of the reference plate is adjustable to simultaneously manipulate the angle of the illumination source and the photosensitive array, relative to the part.

25. The system according to claim 22, wherein the means for conveying the part is a V-track and the V-track includes a gap configured to allow the sheet of light to intersect the part around the full circumference of the part.

26. The system according to claim 22, wherein the output of the photosensitive array is a digitized image having a plurality of picture elements corresponding to the sheet of light intersecting the part, the processor is configured to identify the plurality of picture elements, and the processor is configured to determine the presence of cracks by identifying discontinuities in the plurality of picture elements.

27. A method for detecting cracks on a part comprising:
projecting a sheet of light onto a part;
imaging the reflected light from the part onto a light sensing array;
digitizing the image from the sensing array;
identifying a plurality of picture elements of the digital image corresponding to the sheet of light intersecting the part; and
determining the presence of cracks on the part by analyzing the spatial relationship of the plurality of picture elements.

28. The system according to claim 27, further comprising determining the presence of cracks by identifying discontinuities in the plurality of picture elements.

29. The method according to claim 28, further comprising sensing the position of the part.

30. The method according to claim 29, further comprising transporting the part along a track.
